(19) United States
(12) Patent Application Publication
(10) Pub. No.: US 2019/0362437 A1
(43) Pub. Date: Nov. 28, 2019

(54) SYSTEM AND METHOD FOR DETERMINING DAILY PROFIT AND LOSS TO IMPROVE THE EFFICIENCY OF DAY TO DAY BUSINESS OPERATIONAL ACTIVITIES

(71) Applicant: Yong FOO, PETALING JAYA, SELANGOR (MY)

(72) Inventor: Yong FOO, PETALING JAYA, SELANGOR (MY)

(21) Appl. No.: 16/485,042

(22) PCT Filed: Jun. 19, 2017
(86) PCT No.: PCT/MY2017/000022

§ 371 Date: Aug. 9, 2019

(30) Foreign Application Priority Data
Apr. 27, 2017 (MY) PI 2017000618

(51) Int. Cl. G06Q 40/00; G06Q 10/08; G06Q 30/06; G06Q 30/04

(52) U.S. Cl. CPC G06Q 40/12; G06Q 10/087; G06Q 40/125; G06Q 30/04; G06Q 30/0635

(57) ABSTRACT

The present invention relates to system and method for determining daily profit and loss to improve the efficiency of the current day to day business operational activities. One of the advantages of the system of the present invention, it reduces redundancy of the replications of cost and time by assigning work digitally rather than manually in daily profit and loss calculation. The system further provides a complete visibility of sales volumes, backlogs and trends which allows the decision maker to react at a quicker reaction to spikes in demand of business activities. The system also helps to develop a full understanding of the benefits before committing significant further resources into a business expansion. This ensures that only the businesses which are expected to provide benefits exceeding the investment of time and money are initiated. Moreover, the management of an organization is able to see visible leakage in efforts and time but also promotes to take necessary action to reduce the risks in a business investment.

### FIELD OF THE INVENTION

The present invention relates to system and method for determining daily profit and loss to improve the efficiency of the current day to day business operational activities. Particularly, for determining an accounting state and a financial state of a business by calculating profit-and-loss statements or/and balance sheets.

### BACKGROUND OF THE INVENTION

With the current bearish global market sentiment, corporations around the world are more focused on cutting costs and increasing performances within an organisation. The performance management of the organisation has been a major focus among global corporations to achieve this objective and to have a better understanding of the drivers of corporate profitability. The performance management has been crucial in addressing both operational and financial performance to include the process of collecting the data; performing analysis and reporting in a collaborative fashion for executives, managers, and staff through all levels of an organization.

One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, procurement, stocking and delivery tracking, provision of data services and software, reservations, enterprise data storage, or global communications. In addition, information handling systems may include a variety of hardware and software components that may be configured to process, store, and communicate information and may include one or more computer systems, data storage systems, and networking systems.

The prior art JP2003141344A (filed by Seiko Instruments Inc.) disclosed the business administration system is provided with a managing server connected through a network and manages profit and loss of each company operating a plurality of the stops. The managing server is provided with a daily profit and loss managing part having a sales managing means for summing up daily sales results of the respective shops and preparing sales data, expenditure managing means for roughly calculating daily expenditure of the respective shops and preparing expenditure data and a profit and loss managing means for preparing daily profit and loss data from the sales data and the expenditure data, for managing the daily profit and loss of each shop, and a monthly profit and loss managing part for managing monthly profit and loss of each shop or company. However, such system merely provides estimation on each category such as expenditure management means, aggregates and attendance management means to estimate the labor costs, and product management means to estimate the cost of raw materials, and water utility costs management means to estimate the water utility costs, and other expenses business management. Thus, the daily profit and lost statement or balance sheet generated is therefore inaccurate for decision maker of a corporation. In addition, auto-generation of report for fully integrated component of the system for determination of the daily profit and loss is not available too. For instance, the aggregates and attendance management means to estimate the labor costs, and product management means to estimate the cost of raw materials, and water utility costs management means to estimate the water utility costs, and other expenses business management do not provide a summary report and details breakdown of each category expenses into a report to be reviewed and scrutinized for the purposes of evaluating daily profit and loss. In addition, the system does not provide a real-time calculation of daily profit and loss in each section of the business unit but rather accumulated in each retail before sent to the management server located in headquarter to perform the calculation of the daily profit and loss.

In view of the above shortcomings, the present invention aims to provide system and method for determining daily profit and loss to improve the efficiency of the current day to day business operational activities in each department in real time. Particularly, for determining an accounting state and a financial state of a business by calculating profit-and-loss statements or/and balance sheets. In addition, such system can be conveniently installed and maintained in a simple technical process, low cost with high efficiency.

### SUMMARY OF THE INVENTION

The present invention provides a computer system providing determination of the daily profit and loss of a business, comprising an inventory and purchasing module having a database for storing customers' inventory information, inventory and cost information for a plurality of suppliers wherein the inventory and purchasing module monitors inventory levels and generates orders to cover anticipated shortages of each item in the inventory in daily basis; an order processing and sales module for receiving a list of selected orders from the customer on a pre-ordered item and connected to the inventory and purchasing module for determining the item as requested by the customer available within the inventory and purchasing module based on the daily order processing followed by determining on a final list of orders delivered to the customer and to generate an invoice for payment to be paid by the customer; a human resource module to determine a daily salary of each individual employee based on the number of working days of each individual employee; an account management module for providing electronic data storage means for storing daily accounts receivable and accounts payable information and data entry means for entering accounts receivable and accounts payable information reflecting a daily ledger; and a financial reporting module for generating a daily profit and loss report by retrieving the information from the daily ledger.

One of the advantages of the system and method for determining daily profit and loss to improve the efficiency of the current day to day business operational activities is that it reduces time and labour. The system provides a cloud based setup and without physical setup at their site. Thus, it is affordable for anyone from small enterprise to big corporation. The system of the present invention is operated based on subscription and customize according the requirements of the business owners in each sector of industries to determine the daily profit and loss.

The system of the present invention provides to streamline, monitor and effectively improve yield from the workforce of any organization. By providing a real-time report and status of each department or section of a business unit, the performance of the workforce, managers and business owners are able to take preventive actions to mitigate any loss or over runs.

Moreover, this system allows for more effective workload planning and provides the employee to self-monitor their performance and progress. On-Time and All-the-time ability to track progress and assign work in a business will allow businesses to achieve lower turnaround time. This will directly result in cost reduction as the system focuses day-to-day activities with a big impact on the performance of the organization.

Further advantages of the system in accordance with the invention and its application can be derived from the description and the accompanying drawings. The above mentioned features and those to be further described below can be utilized in accordance with the invention individually or collectively in arbitrary combination. The embodiments mentioned are not to be considered exhaustive enumerations, rather have exemplary character. The invention is shown in the drawings and explained more closely with reference to embodiments.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 illustrates main components interconnected of a computer-implemented system for providing determination of the daily profit and loss of a business in accordance of the present invention.

FIG. 2 illustrates a detail flow chart of interconnected of a computer-implemented system for providing determination of the daily profit and loss of a business in accordance of the present invention.

FIG. 3 illustrates a flow chart of an account management module in a computer-implemented system for providing determination of the daily profit and loss of a business in accordance of the present invention.

FIG. 4 illustrates an example of daily profit financial reporting in a computer-implemented system for providing determination of the daily profit and loss of a business in accordance of the present invention.

FIG. 5 illustrates an example of daily loss financial reporting in a computer-implemented system for providing determination of the daily profit and loss of a business in accordance of the present invention.

FIG. 6 illustrates an example of daily profit and loss in weekly financial reporting in a computer-implemented system for providing determination of the daily profit and loss of a business in accordance of the present invention.

FIG. 7 illustrates an example of daily profit and loss in monthly financial reporting in a computer-implemented system for providing determination of the daily profit and loss of a business in accordance of the present invention.

### DETAILED DESCRIPTIONS OF THE INVENTION

The present invention will now be described in detail in connection with specific embodiments with reference to the accompanying drawings. Unless the context requires otherwise, throughout the specification and claims which follow, the word “comprise” and variations thereof, such as, “comprises” and “comprising” are to be construed in an open, inclusive sense that is as “including, but not limited to”. Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (“IC”), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (“PBX”). In any of these cases, implementation may be achieved either by writing applications that are native to the chosen platform, or by interfacing the platform to one or more external application engines.

The term “customer” refers to a buyer of products via the present invention. Customers can have “open account” relationships to avoid credit card and COD shipment problems. The term “supplier” of the present invention, refers to distributors, manufacturers, or other vendors (collectively “suppliers”), are distinguished by whether they are using the present invention's inventory and purchasing module software, and therefore have live Internet linkages into their databases for queries, order processing, and billing. The term “products” refers to items for sale via the present invention.

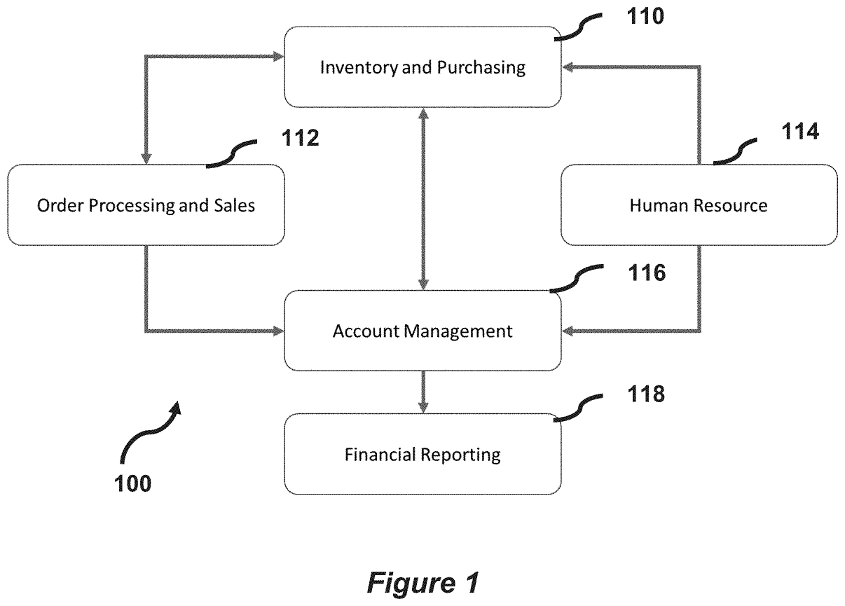

FIG. 1 illustrates main components interconnected of a computer-implemented system for providing determination of the daily profit and loss of a business in accordance of the present invention. A computer system providing determination of the daily profit and loss of a business (100), having few main modules. An inventory and purchasing (110) module having a database for storing customers' inventory information, inventory and cost information for a plurality of suppliers wherein the inventory and purchasing module monitors inventory levels and generates orders to cover anticipated shortages of each item in the inventory in daily basis. Next, an order processing and sales (112) module for receiving a list of selected orders from the customer on a pre-ordered item and connected to the inventory and purchasing module for determining the item as requested by the customer available within the inventory and purchasing module based on the daily order processing followed by determining on a final list of orders delivered to the customer and to generate an invoice for payment to be paid by the customer. Meanwhile, a human resource (114) module is provided to determine a daily salary of each individual employee based on the number of working days of each individual employee. An account management (116) module is formed for providing electronic data storage means for storing daily accounts receivable and accounts payable information and data entry means for entering accounts receivable and accounts payable information reflecting a daily ledger. A financial reporting (118) module is provided for generating a daily profit and loss report by retrieving the information from the daily ledger. All these main modules in a computer-implemented system for providing determination of the daily profit and loss of a business are integrated and providing an information based on real-time transaction. In addition, any variations and modifications of such addition of new module is allowable in system of the present invention for purposes for adaption and suitability of different requirements of any sector of businesses such a manufacturing, legal firm, accounting firm, education, hotel management and others.

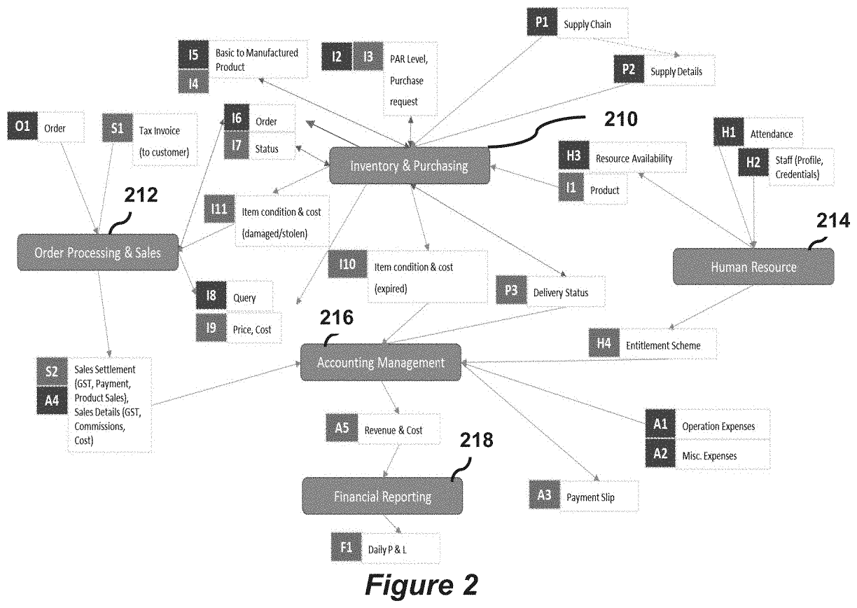

FIG. 2 illustrates a detail flow chart of interconnected of a computer-implemented system for providing determination of the daily profit and loss of a business in accordance of the present invention based on the example of a retailer. The two-way arrow (⇄) in the flow chart, illustrates an information provided in one way direction and vice versa communication between the modules involved. Meanwhile, the one-way arrow (→) illustrates for one way direction, the information flows from the first module to the subsequently module. A user interface is provided to any supplier for providing the retailer of the supply chain (P1) with supply details (P2) such as cost of the item or product, expiry date, location of manufacturer of the goods, availability of the goods, or any other equivalent information as required by the retailer. The inventory and purchasing module further providing an interface through which the suppliers can assess the information in the database according to the assigned permission and determining whether each item from a selected order has been delivered.

The information can be uploaded by any supplier through the web based application and subsequently will be sent to the inventory and purchasing (210) module for the retailer to put in order after considering pre-determined requirements are selected from a price of the item supplied, an expiry date of the item supplied, an availability of the item supplied, an inventory par level as pre-determined and any other equivalent requirement. In the inventory and purchasing (210) module, each item will be provided with a unique barcode for identification and labelling of a product. In the event that the stock of the identified item falls below the pre-set inventory par level (I2), the inventory and purchasing module will send a notification to the selected supplier to put in order for purchasing the identified item (I3) to fill in the stock of the identified product until the inventory par level reaches to the minimum level as pre-determined and within a pre-determined period in the system. The inventory and purchasing module further tracks the inventory items in the database for removing any expired item in the inventory.

For the purposes of the services required to sector of businesses such as hotel management, IT professional services and any other services provided by the employee, such services and availability of man power (H3) will be notified and updated in the inventory and purchasing module in another embodiment. For instance, these services are charged based on hourly rate. The services provided will be categorized as a product (I1) in the inventory and purchasing module to further keep tracking the availability services to the customer in the hotel management services. Meanwhile, in production and manufacturing sector, the information (I4, I5) on the volume of manufactured of the product and raw materials used for manufacturing and production will be stored and to be kept tracking in the inventory and purchasing module.

Meanwhile, the order processing and sales (212) module as illustrated in FIG. 2 further interconnected with the inventory and purchasing (210) module for tracking the order availability (I6) as requested by the customer (O1) and the inventory and purchasing (210) module will provide real-time response and notification on the status (I7) availability of such order to the order processing and sales (212) module. Upon confirmation, an invoice (S1) will be issued by the order processing and sales (212) module to the customer for payment. For the purposes of reference on any inquiry (I8) on the cost of the item ordered by the customer from the order processing and sales (212) module and price of the item sold as well as the original cost of the item purchased from the supplier (I9) are available and provided by inventory and purchasing (210) module can be viewed and identified real-time. In addition, the order processing and sales (212) module of the present system, categorises the invoice paid by the customer (S2) into original cost of the item as paid to the supplier, profit made from the sales, goods and service tax of the invoice, commission paid to each employee for the invoice and any other related cost incurred based on the daily sales (A4) before sent to an account management (216) module. For those goods or products are expired (I10), the cost of such items will be determined losses incurred before sent to the accounting management (216) module. Meanwhile for those goods damaged or stolen, the cost of such items will be determined and sent to order processing and sales module (I11) and subsequently such loss will be calculated in the accounting management (216).

The human resource (214) module as the same time further determines daily commission and allowance of each employee based on the attendance (H1) and number of working hours of each employee based on daily calculation as entitlement scheme (H4) before sent to the account management (216) module. The human resource module further provides human resource reporting and data capture of recruiting information (H2), employee benefits administration, employee compensation, employee education, employee qualifications, and employee terminations, such that the employment life cycle is captured and human resource reports generated. In the account management module, each transaction performed in daily sales and operation will be received and processed according to profit and loss calculation in real-time. Such information is provided by each module in the system from inventory and purchasing (210) module, order processing and sales module (212) and human resource (214) module upon entering the information into the respective module. Since all the information in the system of the present invention is real-time, it is solely depending on the owner of the business or retailer to determine the closing time of business for determination the daily profit and loss.

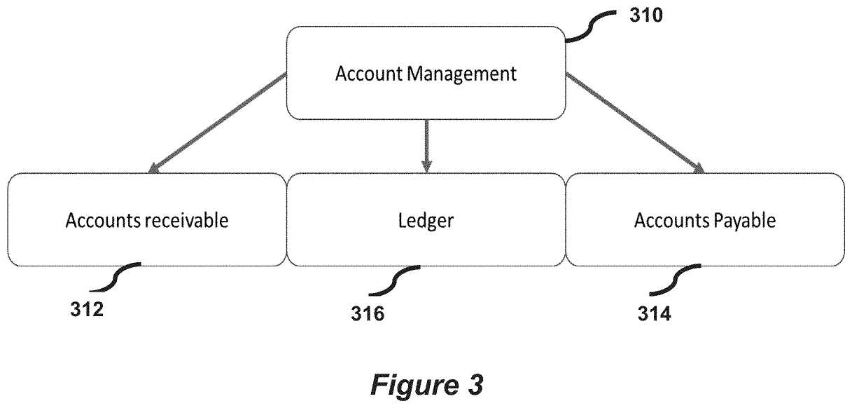

FIG. 3 illustrates a flow chart of an account management module (310) in a computer-implemented system for providing determination of the daily profit and loss of a business in accordance of the present invention. The account management (310) module further comprising an accounts receivable (312) submodule for determining daily sales revenue from the invoices issued and paid by the customers, an accounts payable (314) submodule for determining the daily cost payable for suppliers, entitlement scheme of each employee, daily operation, good and services tax based the daily sales, and any equivalent and a ledger (316) submodule for processing a total sum of the accounts receivable and a total sum of accounts payable and to determine the final amount for daily profit and loss statement. The ledger (316) submodule further analyzing historical daily profit and loss and comparing daily actual profit and loss with a predicted daily profit and loss.

In addition, as shown in FIG. 2, the account management (216) module determines operation expenses (A1) and miscellaneous expenses (A2) such as utility bills, administration and general costs as well as fixed costs such as rental paid by the retailer, cleaning services, security services, depreciation and amortization on the day and other services as required by the retailer or business owner in a daily basis. One of the advantages of the system of the present invention, the payment slip (A3) of the employee can be generated in real-time from the account management (216) module in the event such employee resigns immediately from the job allocated at any time without a hassle to perform any further calculation on the salary of the resigned employee as entitled at a very last minute.

Finally, upon determination of the balance sheet by a ledger submodule in the account management (216) module based on daily profit and loss, the financial reporting (218) module will receive the information based on revenue and cost (A5) to generate the final amount for daily profit and loss statement. In another preferred embodiment of the present invention, the financial reporting (218) module further provides a drill down report on each of the module on daily basis. The financial reporting (218) module can further displaying the retrieved information into a selected graph, a table and a combination of graph and table as required by the retailer or business owner. In view of the calculation of the daily profit and loss of a business of the system of the present invention, it is obvious that monthly, quarterly as well as yearly profit and loss reports are able to be generated and customised by the financial reporting module by taken into account a number of days for daily profit and loss and accumulated accordingly. For instance, if the business owner or retailer would like generate a monthly profit and loss report for 30 days or 31 days, the financial reporting module provides such report by calculating all the 30 days or 31 days, daily profit and loss before finalized into a monthly profit and loss statement. The same applies to quarterly profit and loss statement and yearly profit and loss statement.

For instance, and for the purposes of illustrations, in a retail business environment:

1) Order List is Total items taken through Ordering Module in conjunction with Inventory status

2) Sales Settlement is Total Payment Due (Tax Invoice) and with Total Cost of Goods and Services Sold

wherein

i. Tax Invoice is Order List, Required Payment with goods and services tax (GST);

ii. Total Cost of Goods and Services Sold is cost (of the day) of goods in Inventory added with cost (of the day) of professional service in Inventory;

iii. Goods in Inventory is products sold and manufactured products

iv. Products sold is items purchased from Supplier

v. Manufactured products is end product created by manufacturing processes

vi. Professional Service in Inventory is an availability of service providers (permanent or temporal staff, engaging contractors, etc) determined by Human Resource Module

3) Human Resource (HR) Variable Costs is Staff Entitlement Scheme;

wherein

i. Entitlement Scheme is Basic Salary+Allowance+Commission+Other similar form or equivalents

4) Daily Account Receivables is determined based on the following formulations:

Daily Account Receivables=Daily Sales Transactions+Daily Miscellaneous Incomes+Redeemable Tax−(Daily Inventory Expired Items+Daily Waste)

wherein

i. Daily Sales Transactions are Sum of all Sales Settlements; and

ii. Sales Settlement is a Total Payment Due and Total Cost of Goods and Services Sold

iii. Daily Miscellaneous Incomes are added from Business donations and Customer tips and Unclassified sales of goods or service

iv. Redeemable Tax is goods and services tax (GST) valid for redemption from Government

v. Daily Inventory Expired Items is Total Cost of Goods exceeded its expiry on the day

vi. Daily Waste is Total Cost of Disqualified Goods in its condition on the day (due to damage, rotten, disastrous outcome, native quantity incomplete, native quality incompliance, disagreed service level and similar form or its equivalents

While,

5) Daily Account Payables=Numerous Variable Costs

wherein

i. Variable Costs (Salary, Wages, Commissions) posted from Human Resource (HR) Module

ii. Variable Costs posted from Payment Slip (Utilities, Expenses, Maintenance, Repair)

iii. Petty Cash

iv. Unexpected Loss

Finally,

6) Daily Profit and Loss (PL)=Computed entries computed by Daily General Ledger (GL) for the day

wherein GL is a total balance of daily Account Receivables (AR) and daily Account Payables (AP) posted to Ledger in real-time for the interval of begin and until end of the day or any time as defined as end of business day.

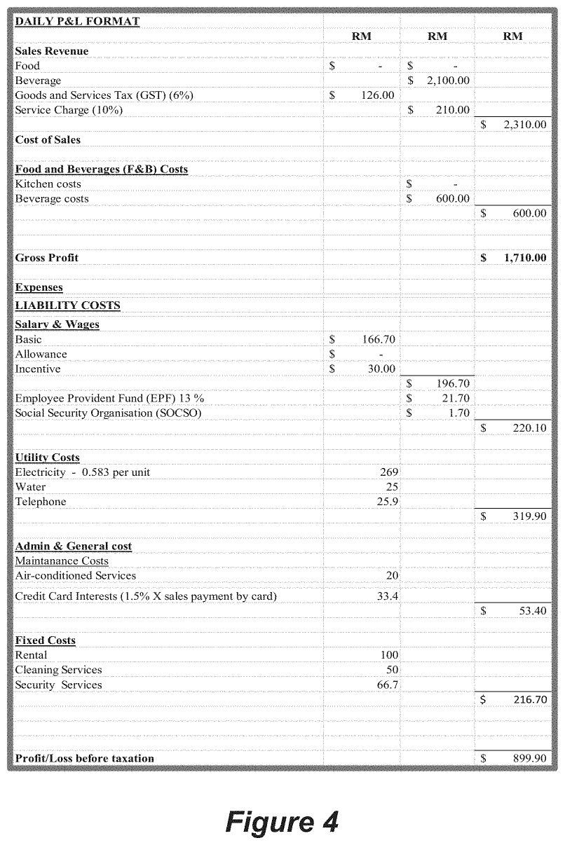

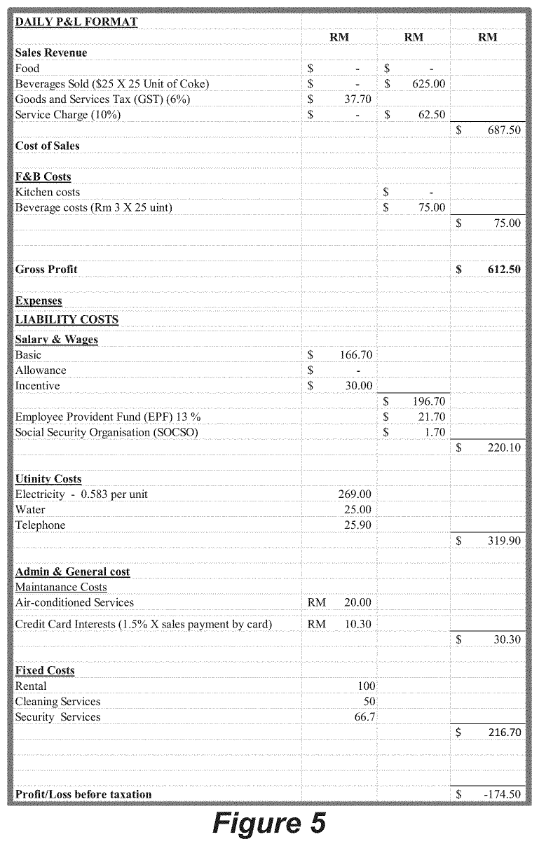

FIG. 4 illustrates an example of daily profit financial reporting in a computer-implemented system for providing determination of the daily profit and loss of a business for a restaurant in accordance of the present invention. The term “RM” refers to Malaysian ringgit currency and can be interchangeably to be replaced with other currency such as US dollar, Singapore Dollar, British Pound and others as required whenever necessary. Meanwhile, FIG. 5 illustrates an example of daily loss financial reporting in a computer-implemented system for providing determination of the daily profit and loss of a business for a restaurant in accordance of the present invention. As can be seen, each daily profit and loss provides details breakdown of the expenses for account payables and also sales generated for account receivables. The system of the present invention allows the business owner or retailer to determine whether any leakages and wastages in daily operation of the business specifically into each department or even each section of the business unit for further investigation with mitigation plan can be implemented to overcome the shortcomings.

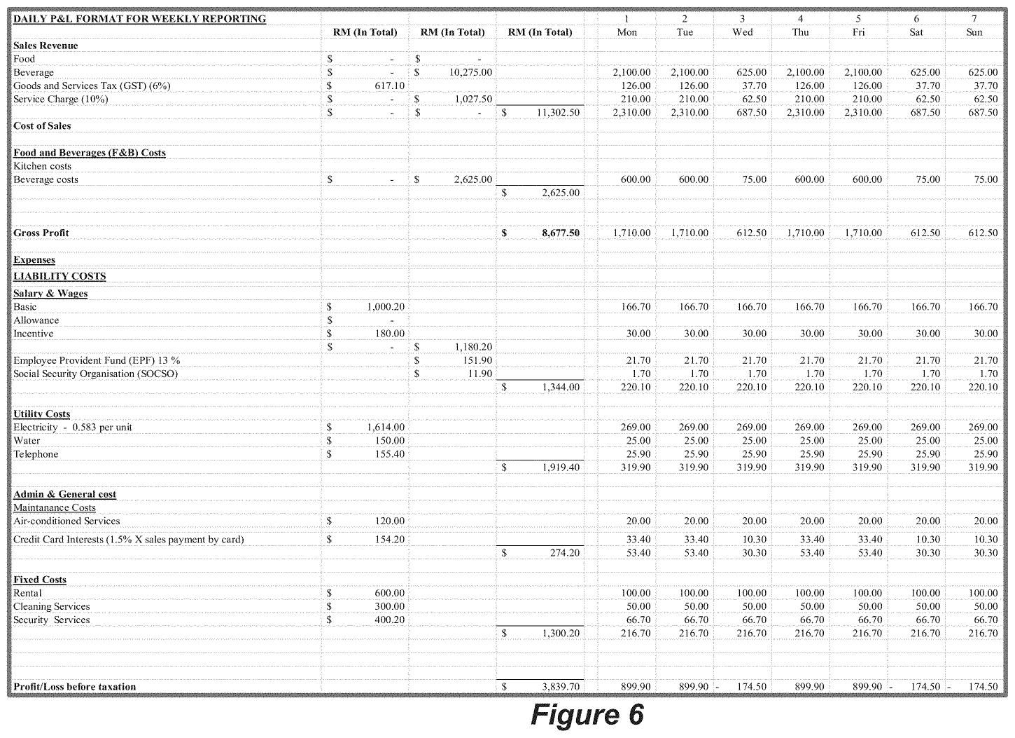

FIG. 6 illustrates an example of daily profit and loss in weekly financial reporting in a computer-implemented system for providing determination of the daily profit and loss of a business in accordance of the present invention. A management of a business can further analyse the weekly financial reporting based on the 7 days operating business hours to determine whether any leakages and wastages in daily operation of the business specifically into each department or even each section of the business unit for further investigation with mitigation plan can be implemented to overcome the shortcomings.

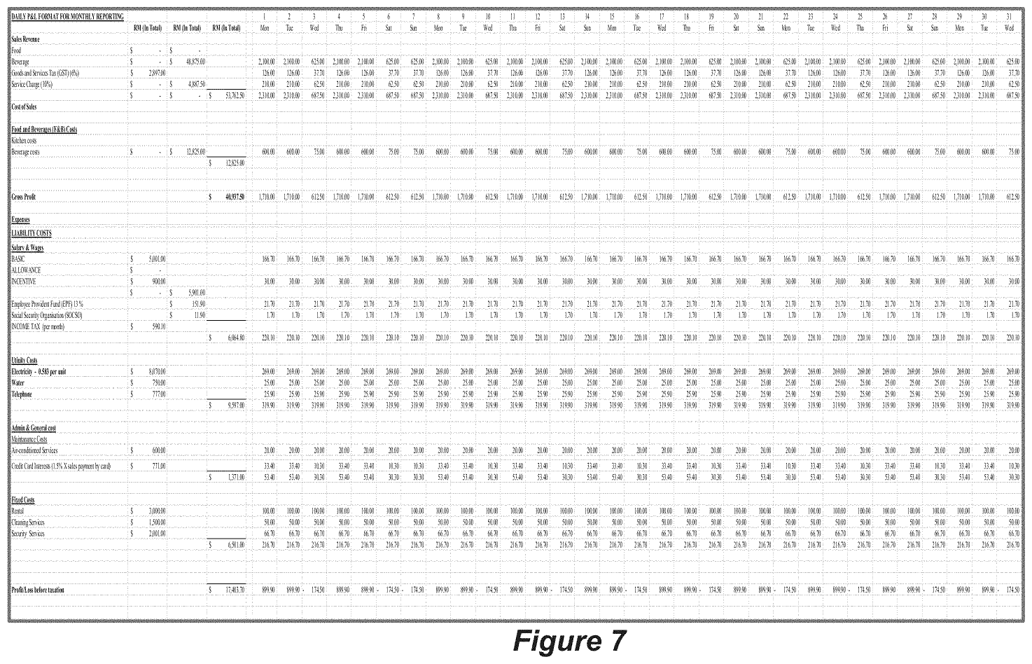

FIG. 7 illustrates another alternative example of daily profit and loss in monthly financial reporting in a computer-implemented system for providing determination of the daily profit and loss of a business in accordance of the present invention. A management of a business can further analyse the monthly financial reporting based on the 31 days operating business hours to determine whether any leakages and wastages in daily operation of the business specifically into each department or even each section of the business unit for further investigation with mitigation plan can be implemented to overcome the shortcomings.

In operation, a computer-implemented method to determine the daily profit and loss of a business, begins with receiving a list of selected orders from the customer on a pre-ordered item in an order processing and sales module and connected to an inventory and purchasing module for determining the item as requested by the customer available within the inventory and purchasing module based on the daily order processing followed by determining on a final list of orders delivered to the customer and to generate an invoice for payment to be paid by the customer. Next, the invoice paid by the customer is categorised into original cost of the item as paid to the supplier, profit made from the sales, goods service tax of the invoice, commission paid to each employee for the invoice and any other related cost incurred based on the daily sales in the order processing and sales module before sent to the account management module. Subsequently, a daily salary of each individual employee based on the number of working days of each individual employee in a human resource module is determined before sent to an account management module. The daily sales revenue from the invoices issued and paid by the customers is determined in an accounts receivable submodule in the account management module. While, the daily cost payable for suppliers, entitlement scheme of each employee, daily operation, goods and services tax based the daily sales, and any equivalent are determined in an accounts payable submodule in the account management module. Finally, a total sum of the accounts receivable and a total sum of accounts payable are determined in a ledger submodule in the account management module and to determine the final amount for daily profit and loss statement to be reported by a financial reporting module.

As noted above, embodiments within the scope of the invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium that can be used to carry or store desired program code in the form of computer-executable instructions or data structures and which can be accessed by a general purpose or special purpose computer. When information is transferred, or provided over a network or another communications connection (either hardwired, wireless, or a combination of hardwired or wireless) to a computer, the computer properly views the connection as a computer-readable medium. Thus, any such connection may be properly termed a computer-readable medium. Combinations of the above are also be included within the scope of computer-readable media. Computer-executable instructions may include, for example, instructions and data which cause a general-purpose computer, special purpose computer, or special purpose processing device to perform a certain function or group of functions.

The invention is described in the general context of operational steps which may be implemented in one embodiment by a program product including computer-executable instructions, such as program code, executed by computers in networked environments. Generally, program code may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a communication of hardwired or wireless links) through a communications network. In a distributed computing environment, program modules may be located in both local and remote memory storage devices.

Other advantage of the system of the present invention, it reduces redundancy of the replications of cost and time by assigning work digitally rather than manually in daily profit and loss calculation. The system further provides a complete visibility of sales volumes, backlogs and trends which allows the decision maker to react at a quicker reaction to spikes in demand of business activities. The system also helps to develop a full understanding of the benefits before committing significant further resources into a business expansion. This ensures that only the businesses which are expected to provide benefits exceeding the investment of time and money are initiated. Moreover, the management of an organization is able to see visible leakage in efforts and time but also promotes to take necessary action to reduce the risks in a business investment.

The foregoing detailed description and examples are merely illustrative of the preferred embodiments. They are by no means meant to be the exclusive description of the inventive concept hereby disclosed. It will be recognized by one of ordinary skill in the art that certain aspects of the practice of the invention are readily susceptible to modification or practice by alternative, known means.

1. A data processing system configured to mitigate leakages and wastages in the daily operation of a business, comprising:
an inventory and purchasing module having a database arranged for receiving and storing data structures, each data structure representing customers' inventory information, inventory and cost information for a plurality of suppliers wherein the inventory and purchasing module is arranged in monitoring inventory levels against pre-determined levels and in generating notification data orders to cover anticipated shortages of each item in the inventory in daily basis;
an order processing and sales module arranged for receiving data structures representing a list of selected orders from the customer on a pre-ordered item and the order processing and sales module being interconnected to the inventory and purchasing module and arranged for determining the item as requested by the customer available within the inventory and purchasing module based on the daily order processing followed by determining on a final list of orders delivered to the customer and to generate invoice data for payment to be paid by the customer;
a human resource module arranged in determining a daily salary of each individual employee based on the number of working days of each individual employee;
an account management module arranged for providing electronic data storage means for storing daily accounts receivable data information and accounts payable data information and
data entry means arranged for entering accounts receivable data information and accounts payable data information reflecting a daily ledger; and
a financial reporting module arranged for generating a daily profit and loss report data by retrieving the accounts receivable data information and accounts payable data information reflecting the daily ledger from the data entry means, wherein
all modules are integrated with each other and arranged in providing data information based on transaction data structures received into the data processing system in real time, said data information enabling to prevent leakages and wastages in the daily operation.

2. The data processing system as claimed in claim 1 wherein the inventory and purchasing module is further arranged in providing data structures representing orders to the supplier based on the pre-determined requirements.

3. The data processing system as claimed in claim 2 wherein the pre-determined requirements are selected from a price of the item supplied, an expiry date of the item supplied, an availability of the item supplied, an inventory par level as pre-determined and other equivalent requirement.

4. The data processing system as claimed in claim 1 wherein the inventory and purchasing module is further arranged in tracking the inventory items in the database for removing any expired item in the inventory.

5. The data processing system as claimed in claim 1 wherein the inventory and purchasing module is further arranged in
providing an interface allowing suppliers to assess the data information in the database according to the assigned permission; and in
determining whether each item from a selected order has been delivered.

6. The data processing system as claimed in claim 1 where order processing and sales module is further arranged in categorizing invoice data representing the invoice paid by the customer into data structures representing the original cost of the item as paid to the supplier, profit made from the sales, goods and service tax of the invoice, commission paid to each employee for the invoice and any other related cost incurred based on the daily sales before sending these data structures to the account management module.

7. The data processing system as claimed in claim 1 wherein the human resource module is further arranged in determining data information representing daily commission and allowance of each employee.

8. The data processing system as claimed in claim 1 wherein the human resource module is further arranged in providing human resource reporting data and arranged in capturing data structures representing recruiting information, employee benefits administration, employee compensation, employee education, employee qualifications, and employee terminations, such that the employment life cycle is captured and human resource reports generated.

9. The data processing computer system as claimed in claim 1 wherein the account management module further comprising
an accounts receivable submodule arranged for determining daily sales revenue data from the invoice data representing invoices issued and paid by the customers;
an accounts payable submodule arranged for determining data structures representing the daily cost payable for suppliers, entitlement scheme of each employee, daily operation, good and services tax based the daily sales, and any equivalent; and
a ledger submodule arranged for processing data structures representing a total sum of the accounts receivable and a total sum of accounts payable and for determining the final amount for daily profit and loss statement.

10. The data processing system as claimed in claim 9 wherein the ledger submodule is further arranged in analyzing historical daily profit and loss data and comparing daily actual profit and loss data with a predicted daily profit and loss data.

11. (canceled)

12. The data processing system as claimed in claim 1 wherein the financial reporting module is further arranged in providing a drill down report on each of the module on daily basis.

13. (canceled)

14. A computer-implemented method to mitigate leakages and wastages in the daily operation of a business, the method comprising:
receiving data structures representing a list of selected orders from the customer on a pre-ordered item in an order processing and sales module and connected to an inventory and purchasing module for determining the item as requested by the customer available within the inventory and purchasing module based on the daily order processing followed by determining on data structures representing a final list of orders delivered to the customer and to generate invoice data for payment to be paid by the customer;
categorizing invoice data representing an invoice paid by the customer into original cost data of the item as paid to the supplier, profit data made from the sales, goods service tax data of the invoice, commission data paid to each employee for the invoice and any other related cost data incurred based on the daily sales in the order processing and sales module before sent to the account management module;
determining a daily salary of each individual employee based on the number of working days of each individual employee in a human resource module before sent to an account management module;
determining daily sales revenue data from the invoices issued and paid by the customers in an accounts receivable submodule in the account management module;
determining the daily cost data payable for suppliers, entitlement scheme data of each employee, daily operation data, goods and services tax data based the daily sales data, and any equivalent data in an accounts payable submodule in the account management module; and
processing data structures representing a total sum of the accounts receivable data information and a total sum of accounts payable data information in a ledger submodule in the account management module and to determine leakages and wastages in the daily operation based on these data information.

15. The computer-implemented method as claimed in claim 14 wherein the human resource module is further arranged in determining data information representing daily commission and allowance of each employee.

16. The computer-implemented method as claimed in claim 14 wherein the ledger submodule is further arranged in analyzing historical daily profit and loss data and comparing daily actual profit and loss data with a predicted daily profit and loss.

17. The computer-implemented method as claimed in claim 14 wherein the method further generating a daily profit and loss statement by a financial reporting module.

18. A computer-readable storage medium comprising instructions which, when executed by a computer, cause the computer to carry out the determination of leakages and wastages in the daily operation of a business comprising steps:
receiving data structures representing a list of selected orders from the customer on a pre-ordered item in an order processing and sales module and connected to an inventory and purchasing module for determining the item as requested by the customer available within the inventory and purchasing module based on the daily order processing followed by determining on data structures representing a final list of orders delivered to the customer and to generate invoice data for payment to be paid by the customer;
categorizing invoice data representing an invoice paid by the customer into original cost data of the item as paid to the supplier, profit data made from the sales, goods service tax data of the invoice, commission data paid to each employee for the invoice and any other related cost data incurred based on the daily sales in the order processing and sales module before sent to the account management module;
determining a daily salary of each individual employee based on the number of working days of each individual employee in a human resource module before sent to an account management module;
determining daily sales revenue data from the invoices issued and paid by the customers in an accounts receivable submodule in the account management module;
determining the daily cost data payable for suppliers, entitlement scheme data of each employee, daily operation data, goods and services tax data based the daily sales, and any equivalent data in an accounts payable submodule in the account management; and
processing a total sum of the accounts receivable data information and a total sum of accounts payable data information in a ledger submodule in the account management module and to determine leakages and wastages in the daily operation based on these data information.
